(19) United States
(12) Patent Application Publication
(10) Pub. No.: US 2007/0192431 A1
(43) Pub. Date: Aug. 16, 2007

(54) Method and apparatus for service oriented architecture infrastructure switch

(75) Inventor: Lei Liu, San Jose, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/351,828

(22) Filed: Feb. 10, 2006

(51) Int. Cl. G06F 15/16

(52) U.S. Cl. 709/217; 709/230

(57) ABSTRACT

A method for processing a service request that includes receiving the service request using a transport protocol, decoupling the service request from the transport protocol to obtain a decoupled service request, normalizing the decoupled service request to obtain a request object, and routing the request object to a first service engine of a plurality of service engines capable of processing the decoupled service request.

### BACKGROUND

Large organizations typically operate one or more data centers to distribute both data and content to inside and outside the organization. The data center typically includes multiple services for serving requests associated with the organization. A service is a software or infrastructure component that provides seamless access to a variety of data center resources (e.g., computation resources and data resources). For example, a computer user may access a web service at the data center through a web page to request the average rainfall in a certain location. As part of responding to the request, the web server may query a database server. The database server sends the answer to the query to the web server, which forwards the answer to the computer user.

Typically, users may request information from the data center using a variety of devices. For example, one user may use a cell phone, while another user accesses the data center using a personal computer. Accordingly, the data center must be able to manage the multiple types of transport protocols from the devices.

Further, access to the data center may be performed from a variety of user applications executing on the devices. For example, a user may request information using a web browser, a word processor, or any of the other variety of applications. Thus, the format of the request and the format of the results vary depending on the application of the user.

Further, services at the data center often use heterogeneous transport protocols and the heterogeneous formats of requests and responses. Specifically, each service at the data center may have a complete set of interfaces (application programming interfaces and graphical user interfaces) for each of the different device types and user applications. Thus, a programmer must program the service to accommodate the different device types.

Alternatively, services at the data center may have a user interface and/or programming interface that a user or user application must understand in order to access the service. Specifically, rather than the user device and application defining the interface, the service defines the interface for communication. Often multiple heterogeneous services are used in the data center. Accordingly, in the alternative solution, user devices and applications are programmed for each of the multiple heterogeneous services.

### SUMMARY

In general, in one aspect, the invention relates to a method for processing a service request that includes receiving the service request using a transport protocol, decoupling the service request from the transport protocol to obtain a decoupled service request, normalizing the decoupled service request to obtain a request object, and routing the request object to a first service engine of a plurality of service engines capable of processing the decoupled service request.

In general, in one aspect, the invention relates to a system for processing a service request that includes a content channel aggregator configured to receive the service request using a transport protocol, decouple the service request from the transport protocol to obtain a decoupled service request, and normalize the decoupled service request to obtain a request object. Further, the system includes a router connected to the bus and configured to route the request object to a first service engine of a plurality of service engines capable of processing the decoupled service request.

In general, in one aspect, the invention relates to a computer usable medium comprising computer readable program code embodied therein for causing a computer system to receive a service request using a transport protocol, decouple the service request from the transport protocol to obtain a decoupled service request, normalize the decoupled service request to obtain a request object, and route the request object to a first service engine of the plurality of service engines capable of processing the decoupled service request.

Other aspects and advantages of the invention will be apparent from the following description and the appended claims.

### BRIEF DESCRIPTION OF DRAWINGS

FIG. 1 shows a schematic diagram of a system for processing a service request using a Service Oriented Architecture (SOA) infrastructure switch in accordance with one or more embodiments of the invention.

FIGS. 2A-2D show flowcharts of a method for processing a service request using a SOA infrastructure switch in accordance with one or more embodiments of the invention.

FIG. 3 shows a computer system in accordance with one embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for processing a service request using a Service Oriented Architecture (SOA) switch in accordance with one or more embodiments of the invention. The SOA relates to a type of software architectural concept in which the use of services supports the requirements of the software users. Specifically, in a SOA, users access services and obtain functionality through services rather than individual nodes. Accordingly, embodiments of the invention provide a mechanism for allowing a user to submit service requests using a variety of formats of data and a variety of transport protocols. Further, embodiments of the invention provide a mechanism whereby services at a data center may have heterogeneous interfaces. Accordingly, embodiments of the invention provide a mechanism whereby neither the user devices and application nor the services must accommodate a variety of interfaces.

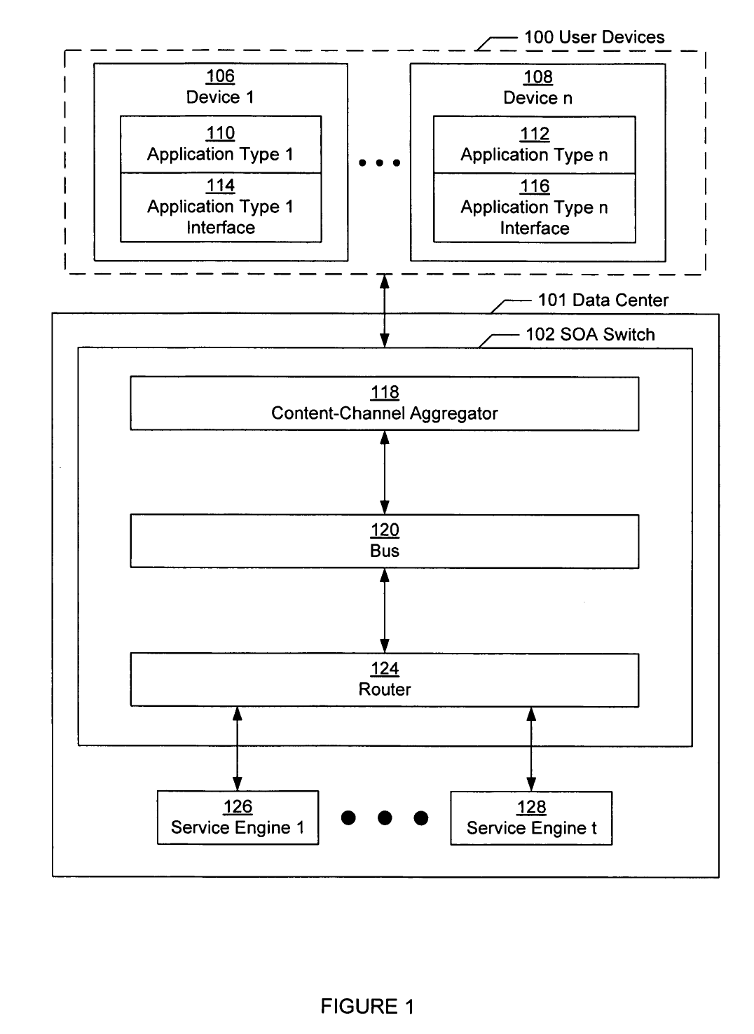

FIG. 1 shows a schematic diagram of a system for processing a service request using a SOA infrastructure switch in accordance with one or more embodiments of the invention. As shown in FIG. 1, the system includes user devices (100) and a datacenter (101) with a SOA switch (102) and multiple service engines (e.g., service engine 1 (126), service engine t (128)). Each of these components is described below.

The user devices (100) correspond to the devices (e.g., device 1 (106), device n (108)) that a user may use to access the data center. Specifically, the devices may correspond to virtually any computing device (e.g., personal computer, server, cell phone, personal digital assistant (PDA), or any other type of computing device). Accordingly, each device (e.g., device 1 (106), device n (108)) may use different protocols (e.g., Wireless Application Protocol (WAP), Hypertext Transfer Protocol (HTTP), Short Message Service (SMS), or any other data transferring technique) for transmitting messages to the data center (101) (described below), such as requests, and receiving information.

Each device (e.g., device 1 (106), device n (108)) has one or more applications (e.g., application type 1 (110), application type n (112)) executing on the device (e.g., device 1 (106), device n (108)). The applications, as shown in FIG. 1, may each be of a different type. For example, a database client may be executing on device 1 (106) and a web browser may be executing on device n (108).

Accordingly, the interface (e.g., application type 1 interface (114), application type n interface (116)) that describes the manner in which the application (e.g., application type 1 (110), application type n (112)) and device (e.g., device 1 (106), device n (108)) communicates with the data center (101) may also vary depending on the application type. Specifically, in one or more embodiments of the invention the interface (e.g., application type 1 interface (114), application type n interface (116)) defines at least one protocol and format for communicating with the data center (101).

Those skilled in the art will appreciate that a single application may have multiple interfaces for communicating with the datacenter. Further, a single device may have multiple types of applications executing on the device.

Continuing with FIG. 1, a data center (101) is connected to the devices (100). A data center (101) corresponds to a grouping of both hardware and software resources that include functionality to operate collectively to service requests that originate both outside of the data center (101) and within the data center (101). Typically, all hardware in a data center (101) is managed by a single organization (e.g., administrator, company, educational institution, etc.). However, those skilled in the art will appreciate that the hardware may be managed in a distributed environment wherein multiple unrelated organizations or people manage a subset of the hardware.

The data center (101) includes a SOA switch (102) and multiple service engines (e.g., service engine 1 (126), service engine t (128)). The SOA switch (102) includes functionality to receive requests in virtually any interface and any protocol, determine the service engine (e.g., service engine 1 (126), service engine t (128)) for processing the request, and route the requests to the correct service engine (e.g., service engine 1 (126), service engine t (128)) in the protocol and format required by the service engine (e.g., service engine 1 (126), service engine t (128)). Accordingly, the SOA switch (102) includes a content-channel aggregator (118), a bus (120), and a router (124). Each of these components is described below.

A content-channel aggregator (118) includes functionality to receive service requests from a device (e.g., device 1 (106), device n (108)), decouple the service request from a protocol and format, and forward the service requests to the bus (120). A service request corresponds to any type of request that for processing by one or more service engines (e.g., service engine 1 (126), service engine t (128)). A service request may correspond to a request for management data (e.g., obtain performance data) or management operations (e.g., to provision an application on the data center (101)) or a request for processing by the services (e.g., execute an application at the data center (101)).

The content channel aggregator (118) includes functionality to decouple the protocol from the request and remove the format sent by the device (e.g., device 1 (106), device n (108)). Specifically, the content channel aggregator (118) includes functionality to remove the protocol used to send the request from the request and normalize the resulting request by creating a request object.

A request object corresponds to a format known by both the content channel aggregator (118) and the router (124) (described below). In one or more embodiments of the invention, the request object corresponds to an object oriented programming object. Specifically, a request object corresponds to a self-contained entity that identifies data and procedures for using the data. More specifically, the content channel aggregator (118) includes functionality to receive a request or a result in virtually any protocol and virtually any format and transform the request or result into a single standardized format.

Further, the content channel aggregator (118) includes functionality to determine the format and protocol for transmitting results back to the device (e.g., device 1 (106), device n (108)). Additionally, the content-channel aggregator may also include functionality to combine or aggregate results obtained from multiple different service engines (e.g., service engine 1 (126), service engine t (128)).

The bus (120) corresponds to a high throughput, multi-threaded storage unit. In one or more embodiments of the invention, the bus (120) corresponds to a queue. A bus (120) corresponds to any type of data structure (e.g., object-oriented queue, vector, tree, heap, etc.) and any storage mechanism (e.g., database, file(s), etc.) for storing requests and results until the requests or the results are processed (i.e., used and removed from the queue). The bus (120) allows for asynchronous processing of requests. Further, in one or more embodiments of the invention, the bus (120) is a priority-based. Specifically, requests and/or results are processed in a certain order, such as first in first out, smallest object processed first, or according to an order defined by the content channel aggregator (118) and/or device (e.g., device 1 (106), device n (108)). For example, a request or result sent from or to an administrator may be granted higher priority than a request from a non-administrative user.

The bus (120) is connected to a router (124). The router (124) corresponds to a software component that includes functionality to determine a service engine (e.g., service engine 1 (126), service engine t (128)) (described below) for processing the request, and to send the request to the service engine (e.g., service engine 1 (126), service engine t (128)). In one or more embodiments of the invention, the router (124) corresponds to a multi-threaded software component to provide asynchronous processing of requests to the appropriate service engine (e.g., service engine 1 (126), service engine t (128)).

Accordingly, the router is connected to multiple service engines (e.g., service engine 1 (126), service engine t (128)). A service engine (e.g., service engine 1 (126), service engine t (128)) correspond to a component that provides a service. Specifically, the service engine includes functionality to communicate with the hardware and software (not shown) executing at the data center. In one or more embodiments of the invention, the service engine (e.g., service engine 1 (126), service engine t (128)) provides an entry point to access services, such as database services, at the data center. Specifically, each service engine may include functionality to determine at least one node(s) in the data center (101) for processing the request and schedule the request on the node(s). Accordingly, the service engine may correspond to a web service, an application service, a transformation service, and a collaboration service. The aforementioned exemplary services are described below.

A web service corresponds to any service related to the Internet. For example, a web service may correspond to a calendar service, a messaging service, portal service, a service for answering web page requests, etc.

An application service corresponds to any service that allows users to access applications that would otherwise be located on the personal computer of the user. For example, an application service may correspond to a word processor that is distributed over a network, a software development application, a file system management application, and other such application services.

Continuing with different types of service engines, another type of service engine is a transformation service. A transformation service corresponds to a software component that includes functionality to perform a mapping between a request object and a particular hardware device. For example, the transformation service includes functionality to transform a generic storage request into a request for a particular storage unit device type.

A collaboration service is a service that is able to collaborate execution between multiple services. For example, one type of collaboration service is a management service. A management service includes functionality to provision and update software and hardware at the data center (101), monitor the data center (101), gather performance information, track usage, discover new hardware and software components, and/or perform load balancing for software executing at the data center (101). In order to process a management request, the management service may provide one or more probes (not shown) at the data center (101). A probe corresponds to a lightweight software module for gathering information about the execution of hardware or software. A probe is typically embedded into software executing at the data center (101). An example of a probe is a developed by Sun Microsystems, Inc. (located in Santa Clara, CA USA). Those skilled in the art will appreciate that other types of probes may also be used. A collaboration service may include administrator involvement in the processing of requests.

Those skilled in the art will appreciate that while only a few exemplary types of service engines (e.g., service engine 1 (126), service engine t (128)) are described, other types of service engines may also exist. Further, in one or more embodiments of the invention, the service engines (e.g., service engine 1 (126), service engine t (128)) are all connected to a single identity manager (not shown). Specifically, the identity manager corresponds to a storage unit, such as a directory server, and a management unit that is configured to determine whether a given user and/or device (e.g., device 1 (106), device n (108)) can use a particular service engine (e.g., service engine 1 (126), service engine t (128)). Specifically, a centralized identity manager allows for single sign-on to a service engine (e.g., service engine 1 (126), service engine t (128)) in the data center (101) and through Liberty Identity Federation access other service engines also at the data center (101). Liberty Identity Federation corresponds to an idea that a user may be authenticated to access one service engine (e.g., service engine 1 (126), service engine t (128)) and by the authentication and a mutual agreement between two service engines be able to access a second service engine without authentication to the second service engine.

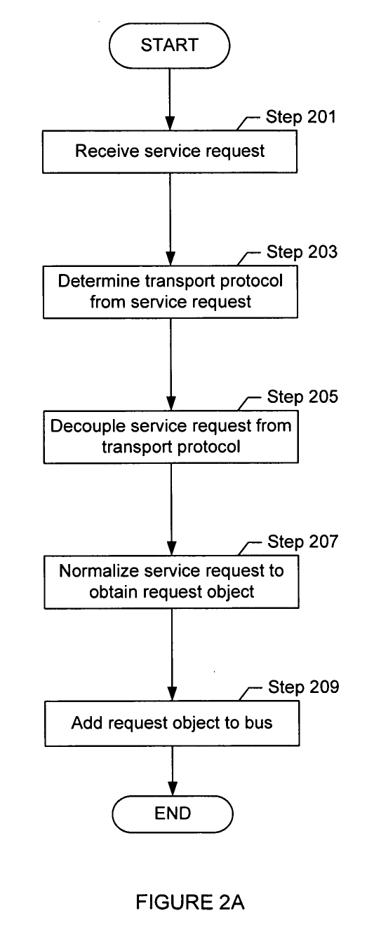

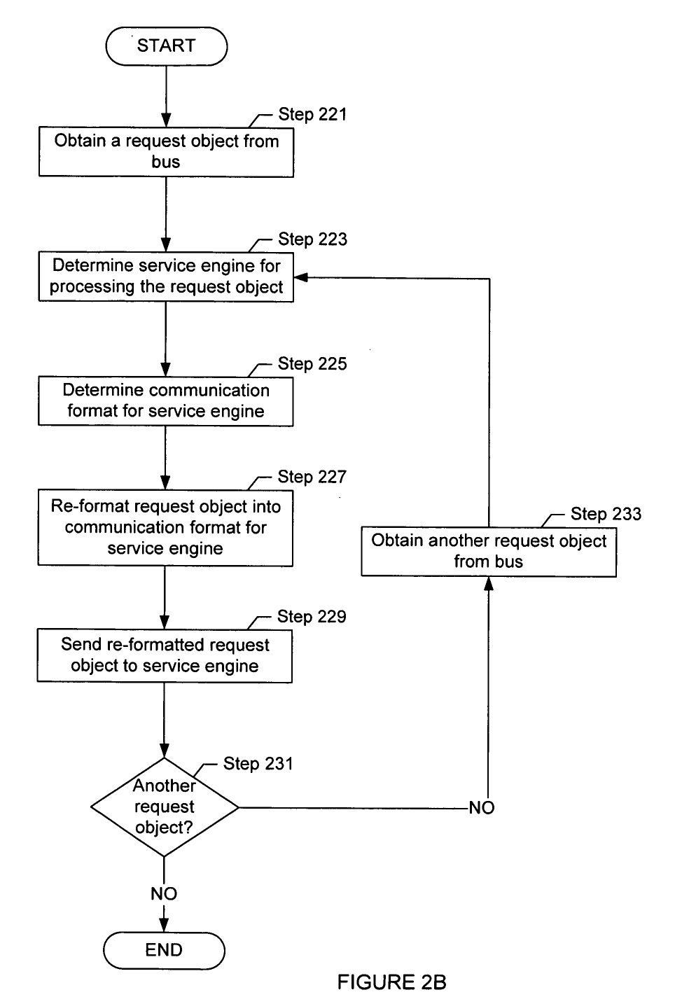

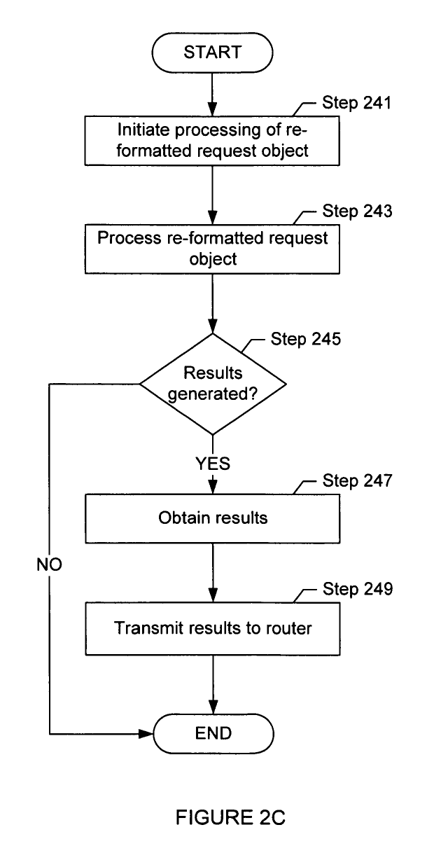

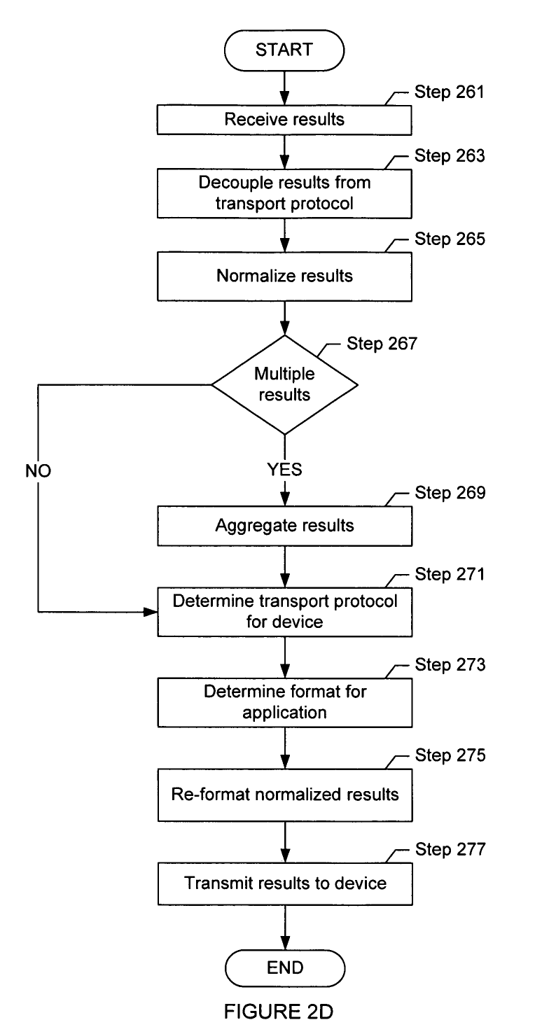

FIGS. 2A-2D show flowcharts of a method for processing a service request using a SOA infrastructure switch in accordance with one or more embodiments of the invention. Typically, the processing of service requests are performed in parallel. For example, as objects are added to the bus, objects are removed from the bus. By processing services requests in parallel, throughput of service requests increases.

FIGS. 2A shows a flowchart of a method for processing a service request by a content channel aggregator using a SOA infrastructure switch in accordance with one or more embodiments of the invention. Initially, a service request is received by the content channel aggregator (Step 201). The content channel aggregator is able to understand a variety of protocols and formats for sending service requests. Accordingly, the service request may be received from the content channel aggregator using a virtually any protocol or format. Those skilled in the art will appreciate that before processing of the service request, the content channel aggregator may or may not wait until all packets are received.

After receiving the service request, the protocol is determined from the service request (Step 203). The content channel aggregator may store information about the protocol in a separate storage area for future communication with the device and application.

After determining the transport protocol from the service request, the service request is decoupled from the transport protocol. Specifically, all protocol specific portions of the request are removed from the request. Those skilled in the art will appreciate that information about the removed portions, such as protocol used and any other information, may be stored with the request as metadata.

Next, the service request is normalized to obtain a request object (Step 207). Normalizing a service request involves changing the service request into a standardized format. Specifically, the order and/or method storing data in the request changes. More specifically, a request object is produced.

After obtaining the request object, the request object is added to the bus (Step 209). Those skilled in the art will appreciate that adding the request object to the bus may require such devices as semaphores, monitors, managing threads, and other such devices to prevent simultaneous access to the bus or a portion thereof. Specifically, while the bus is multi-threaded, those skilled in the art will appreciate that adding the request object to the bus should complete before the removal of the same request object from the bus.

FIGS. 2B shows a flowchart of a method for processing a service request from a request object by a router using a SOA infrastructure switch in accordance with one or more embodiments of the invention. Specifically, FIG. 2B shows a method for routing request objects from the bus in an asynchronous manner. Initially, the request object is removed from the bus (Step 221). In order to remove a request object from the bus, a consumer thread connected to the router removes the object and passes the request object to a thread of the router. By separate threads for removing request objects and router threads, the router maintains independence from the bus. However, those skilled in the art will appreciate that the router threads may also perform the removal of the request objects. In addition, when the bus is priority based, then the request object that is removed is the request object with the highest priority in accordance with one or more embodiments of the invention. Further, similar to adding the request object to the bus, removing the request object from the bus may also require locking or monitoring devices.

Next, the service engine for processing the request object is determined (Step 223). Because the request object is in a standardized format, the router is able to access data easily within the request object that is required for determining the service engine. Specifically, the router may use a rules engine that defines how to route a request object if the data in the request object is requesting a particular functionality, such as to object management data.

After determining the service engine for processing the request object, then the communication format for the service engine is determined (Step 225). Specifically, the service engines may be heterogeneous with respect to the format for data. For example, if the service engines are from third party vendors, then each third party vendor may have a different required format for requests. Accordingly, the router use prior information about the service engine to determine the format for the request object.

Next, the request object is re-formatted into the communication format for the service engine (Step 227). Specifically, the addressing and request information is transformed into the format that the service engine can interpret. The re-formatted request object is then sent to the service engine for processing (Step 229).

After sending the re-formatted request object to the service engine, a determination is made whether another request object is on the bus (Step 231). If another request object is on the bus, then the next request object is obtained from the bus (Step 233) and the service engine for processing the next request object is determined (Step 223).

Alternatively, if no more request objects are found on the bus, then a thread consumer thread waits until inbound request objects are placed on the bus. Those skilled in the art will appreciate that multiple requests objects may be removed and manipulated from the bus simultaneously. Specifically, multiple threads may be used whereby each thread routes a single request object or each thread performs a specific function with the request objects. Accordingly, the bus and the router provide a high throughput mechanism for directing requests to the appropriate service engine.

FIGS. 2C shows a flowchart of a method for processing a service request by a service engine using a SOA infrastructure switch in accordance with one or more embodiments of the invention. A re-formatted request object may be received from the router or as a scheduled event (e.g., performance data is to be provided every day at noon). Initially the processing of the re-formatted request object is initiated (Step 241). Specifically, the re-formatted request object is obtained and the application and hardware for processing the request object is determined.

Further, at this stage or before accessing the request object, a determination may be made whether the user and/or device associated with the request object is authorized and/or authenticated to use the service engine in accordance with one or more embodiments of the invention. Accordingly, the service engine may send an identity request to the identity manager. If the user is previous authorized and authenticated to use a different service engine, then the identity manager checks whether the user has the credentials for the current service engine. Specifically, various service engines at the data center may allow for reciprocity between service engines.

Continuing with FIG. 2C, next, the re-formatted request object is processed (Step 243). Processing of the re-formatted request object may be performed in a variety of manners specific to each service engine. Further, each service engine may use one or more other service engines in order to process the request object.

After processing the request object, a determination is made whether results are generated (Step 245). If no results are generated, then the processing by the service engine completes. Alternatively, if results are generated, then the results are obtained (Step 247). The results from a single service engine may be concatenated by the service engine.

After obtaining the results, the results are transmitted to the router (Step 249). The service engine transmits the results using a format and protocol known to the service engine and router. Further, in one or more embodiments of the invention, transmitting the results to the router may be performed in a similar manner to transmitting the results directly to the user. Specifically, the router may act as a spoof in which the service engine is not aware of the router.

FIGS. 2D shows a flowchart of a method for processing a service request by transmitting results to the device using a SOA infrastructure switch in accordance with one or more embodiments of the invention. Initially, the results are received by the router (Step 261). Next, the router decouples the results from the protocol (Step 263). Decoupling the results from the protocol may be performed in a similar manner as decoupling the request from the protocol (described in FIG. 2A). Next, the results are normalized (Step 265). In one or more embodiments of the invention, results are transported in a manner similar to how requests are transported. Specifically, when transporting results to the device, the router acts as the channel content aggregator and the channel content aggregator act as the router.

After normalizing the results, the results may be added to the bus in a separate results queue or sent to the channel content aggregator. Regardless of how the results arrive at the channel content aggregator, the determination is made whether multiple results exist (Step 267). Multiple results exist if several service engines produce results for the same application and device. For example, if an application requests an application to be provisioned, then a service engine responsible for the provisioning may send the results of success and a separate service engine responsible for obtain performance information from the provisioning of the application may also send the performance information. Accordingly, when multiple results exist, then the results are aggregated (Step 269). Specifically, the results are combined into a single result package.

Once the multiple results are aggregated or if multiple results do not exist, then the transport protocol for the device is determined (Step 271). Determining the transport protocol for the device may be performed by accessing metadata associated with the results that is attached when the request object is processed or accessing a separate storage unit that maintains the information about device addresses and the transport protocols for the device at the device address. In addition, at this stage, the format for the application at the device is determined (Step 273). Determining the format for the application may be performed in a similar manner to determining the transport protocol. After determining the format for the application, the normalized results are re-formatted into the format for the application (Step 275). Next, the normalized results are transmitted using the transport protocol (Step 277). Transmitting the normalized results using the transport protocol may be performed in virtually any manner known in the art.

For the following example, consider the case in which an administrator wants to determine data center resource utilization. Accordingly, an administrator logs in to the data center, for example, using a mobile phone via secure hypertext transfer protocol (HTTPS).

To view the current data center resource utilization, a service request is pushed from mobile portal channel to the content channel aggregator. The service request is decoupled with transport protocols and invokes normalization engine for transforming the service request to a request object. The request object is published to the switch bus. The bus stores the request object until the router access the request.

After the request object is published on the bus, router determines the service engine, such as management service, that can process the request object. The router than re-formats the request object for the management service using protocol-binding components of the service engine. The re-formatted request object can be further processed by management logic specifics such as performance monitoring request (e.g., getting processor usage of a particular grid node hosting stock quote web service). The probe is invoked on the managed node of the grid fabric. Accordingly, the probes performs data collection and sampling.

Once the data collecting and sampling is completed, the results are sent to a portal container (i.e., normalized result object) and forwarded to bus. The channel content aggregator obtains the results from the bus, re-formats the results into a format for an application on the mobile phone. The re-formatted results are then sent to the mobile phone using HTTPS. Thus, an administrator may determine the usage of the data center while away from any personal computer, such as when the administrator is skiing.

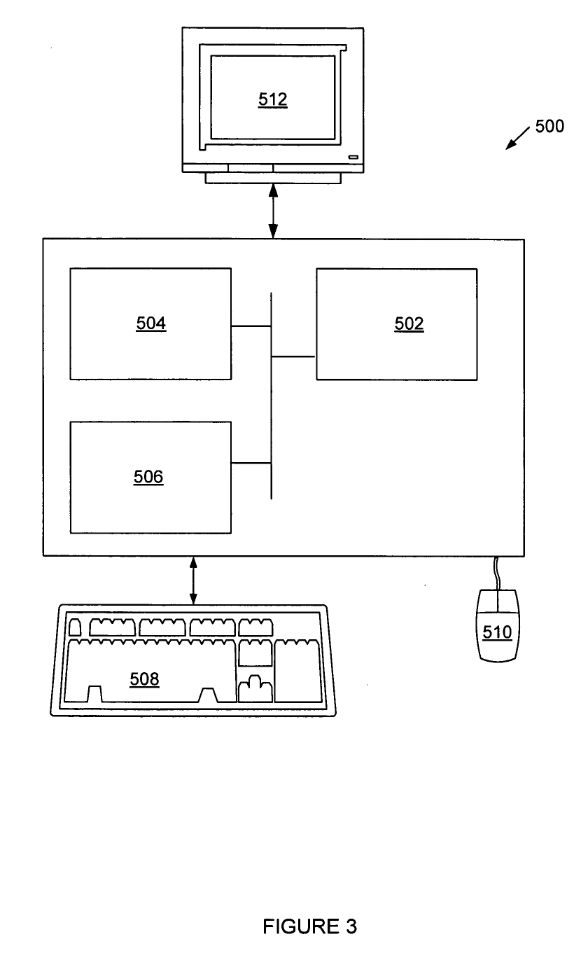

The invention may be implemented on virtually any type of computer regardless of the platform being used. For example, as shown in FIG. 3, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., content channel aggregator, bus, queue, router, services, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a high throughput, highly scalable method for processing service requests in a variety of formats. Specifically, by adding an intermediate SOA switch, neither the client device and nor a particular service engine needs to accommodate different interfaces. Accordingly, as new technologies (i.e., new devices and service engines) are developed, the new technologies may be added without affecting the remaining service engines or devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for processing a service request comprising:
receiving the service request using a transport protocol;
decoupling the service request from the transport protocol to obtain a decoupled service request;
normalizing the decoupled service request to obtain a request object; and
routing the request object to a first service engine of a plurality of service engines capable of processing the decoupled service request.

2. The method of claim 1, wherein routing the request object to the first service engine comprises:
determining a format for the first service engine;
re-formatting the request object into the format for the first service engine to obtain re-formatted request object; and
sending the re-formatted request object to the first service engine.

3. The method of claim 2, wherein routing the request object to the first service engine further comprises removing the request object from a queue.

4. The method of claim 1, wherein routing the request object to the first service engine is performed asynchronously.

5. The method of claim 1, further comprising:
obtaining a result from the first service engine;
determining a format for results to send to a client;
re-formatting the result for the client to obtain a re-formatted result; and
sending the re-formatted result to client using the transport protocol.

6. The method of claim 1, further comprising:
obtaining a plurality of results from the first service engine and a second service engine of the plurality of service engines;
aggregating the plurality of results to obtain aggregated results;
re-formatting the aggregated results for the client to obtain aggregated re-formatted results; and
sending the aggregated re-formatted results to a device using the transport protocol.

7. The method of claim 1, further comprising:
authorizing a client based on the service request, wherein authorizing the client based on the service request comprises:
determining whether client has obtained a previous authorization from a second service engine of the plurality of service engines; and
evaluating the previous authorization for the first service engine.

8. A system for processing a service request comprising:
a content channel aggregator configured to:
receive the service request using a transport protocol;
decouple the service request from the transport protocol to obtain a decoupled service request; and
normalize the decoupled service request to obtain a request object; and
a router connected to the bus and configured to:
route the request object to a first service engine of a plurality of service engines capable of processing the decoupled service request.

9. The system of claim 8, wherein routing the request object to the first service engine comprises:
determining a format for the first service engine;
re-formatting the request object into the format for the first service engine to obtain re-formatted request object; and
sending the re-formatted request object to the first service engine.

10. The system of claim 9, wherein routing the request object to the first service engine further comprises removing the request object from a bus.

11. The system of claim 10, wherein the bus is a queue.

12. The system of claim 8, wherein routing the request object to the first service engine is performed asynchronously.

13. The system of claim 8, wherein the content channel aggregator is further configured to:
obtain a result from the first service engine;
determine a format for results to send to a client;
re-format the result for the client to obtain a re-formatted result; and
send the re-formatted result to client using the transport protocol.

14. The system of claim 8, wherein the content channel aggregator is further configured to:
obtain a plurality of results from the first service engine and a second service engine of the plurality of service engines;
aggregate the plurality of results to obtain aggregated results;
re-format the aggregated results for the client to obtain aggregated re-formatted results; and
send the re-formatted aggregated results to a device using the transport protocol.

15. The system of claim 8, wherein the system is further configured to:
authorize a client based on the service request, wherein authorizing the client based on the service request comprises:
determining whether client has obtained a previous authorization from a second service engine of the plurality of service engines; and
evaluating the previous authorization for the first service engine.

16. A computer usable medium comprising computer readable program code embodied therein for causing a computer system to:
receive a service request using a transport protocol;
decouple the service request from the transport protocol to obtain a decoupled service request;
normalize the decoupled service request to obtain a request object; and
route the request object to a first service engine of the plurality of service engines capable of processing the decoupled service request.

17. The computer usable medium of claim 16, wherein routing the request object to the first service engine comprises:
determining a format for the first service engine;
re-formatting the request object into the format for the first service engine to obtain re-formatted request object; and
sending the re-formatted request object to the first service engine.

18. The computer usable medium of claim 17, wherein routing the request object to the first service engine further comprises removing the request object from a bus.

19. The computer usable medium of claim 16, further comprising:
obtain a result from the first service engine;
determine a format for results to send to a client;
re-format the result for the client to obtain a re-formatted result; and
send the re-formatted result to client using the transport protocol.

20. The computer usable medium of claim 16, further comprising:
obtain a plurality of results from the first service engine and a second service engine;
aggregate the plurality of results to obtain aggregated results;
re-format the aggregated results for the client to obtain aggregated re-formatted results; and
send the re-formatted aggregated results to a device using the transport protocol.
